(19) United States
(12) Patent Application Publication
(10) Pub. No.: US 2007/0141430 A1
(43) Pub. Date: Jun. 21, 2007

(54) Gas scrubber and method related thereto

(76) Inventors: Qunjian Huang, Shanghai (CN); Chang Wei, Niskayuna, NY (US); Richard Louis Hart, Niskayuna, NY (US); Su Lu, Shanghai (CN); Andrew Philip Shapiro, Schenectady, NY (US); John Patrick Lemmon, Schoharie, NY (US); Jinghua Liu, Shanghai (CN)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/313,629

(22) Filed: Dec. 21, 2005

(51) Int. Cl. H01M 8/04; H01M 4/88; B03C 3/40; B03C 3/45

(52) U.S. Cl. 429/34; 502/101; 96/90; 96/98

(57) ABSTRACT

A galvanic cell utilizing a gas scrubber is provided. The galvanic cell may include a galvanic cell unit and a gas scrubber comprising an active material layer, a resistance coil in contact with the active material layer, a first shutter positioned between the active material layer and ambient air, a second shutter may be positioned between the galvanic cell unit and the active material layer.

### FIELD OF TECHNOLOGY

Embodiments of the invention relate to a gas scrubber for use in a fuel cell or battery. Particularly, embodiments relate to gas scrubber for use in a rechargeable fuel cell or metal/air battery.

### BACKGROUND

A fuel cell may convert the chemical energy of a fuel directly into electricity without any intermediate thermal or mechanical processes. Energy may be released when a fuel reacts chemically with oxygen in the air. A fuel cell may convert hydrogen and oxygen into water. The conversion reaction occurs electrochemically and the energy may be released as a combination of electrical energy and heat. The electrical energy can do useful work directly, while the heat may be dispersed.

Fuel cell vehicles may operate with hydrogen stored onboard the vehicles, and may produce little or no conventional undesirable by-products. The byproducts may include water and heat. Systems that rely on a reformer on board to convert a liquid fuel to hydrogen may produce small amounts of emissions, depending on the choice of fuel. Fuel cells may not require recharging, as an empty fuel canister could be replaced with a new, full fuel canister.

Metal/air batteries may be compact and relatively inexpensive. Metal/air cells include a cathode that uses oxygen as an oxidant and a solid fuel anode. The metal/air cells differ from fuel cells in that the anode may be consumed during operation. Metal/air batteries may be anode-limited cells having a high energy density. For example, metal/air batteries have been used in hearing aids and in marine applications.

Alkaline fuel cells, rechargeable fuel cells and metal/air batteries can be sensitive to carbon dioxide in the air due to the use of base electrolytes. The interaction of base electrolyte, and/or the electrodes with carbon dioxide, may cause formation of unwanted byproducts that may interfere with the operation and life of the cell. Currently available carbon dioxide scrubbers may require maintenance and may rely on limited or expendable materials/mechanisms to remove the carbon dioxide.

It may be desirable to have a fuel cell and/or a metal/air battery having differing characteristics or properties than those currently available.

### BRIEF DESCRIPTION

The embodiments of the invention relate a galvanic cell utilizing a gas scrubber. The galvanic cell may include a galvanic cell unit and a gas scrubber comprising an active material layer, a resistance coil in contact with the active material layer, a first shutter positioned between the active material layer and ambient air, and a second shutter positioned between the galvanic cell unit and the active material layer.

Further, embodiments of the invention relate to a gas scrubber comprising an active material layer, a resistance coil in contact with the active material layer, a first shutter positioned between the active material layer and ambient air, a galvanic cell unit, and a second shutter positioned between the galvanic cell unit and the active material layer.

Embodiments of the invention relate to a method of making a galvanic cell. The method may include forming a galvanic cell unit, and forming a gas scrubber, including coupling an active material layer to a resistance coil, positioning a first shutter between the active material layer and ambient air, and positioning a second shutter between the galvanic cell unit and the active material layer.

In addition, embodiments of the invention relate to a method of making a gas scrubber. The method may include forming an active material layer, forming a resistance coil, coupling the resistance coil to the active material layer, forming a first shutter, positioning the first shutter between the active material layer and ambient air, forming a galvanic cell unit, forming a second shutter, and positioning the second shutter between the galvanic cell unit and the active material layer.

Embodiments of the invention also relate to a method of scrubbing. The method may include opening both shutters sufficient to allow ambient air or oxygen to diffuse and come in contact with an active material layer. Sorption of the carbon dioxide, with the active material located within the active material layer, allows the substantially pure air or oxygen to diffuse and come in contact with a galvanic cell unit. The active material layer can be thermally regenerated by closing the second shutter and heating the active material layer through resistive heat or other heat generating methods.

### DESCRIPTION OF THE DRAWINGS

Embodiments of the invention may be understood by referring to the following description and accompanying drawings that illustrate such embodiments. In the drawings:

FIG. 1 illustrates a perspective view of a gas scrubber for use with a galvanic cell, according to some embodiments of the invention.

FIG. 2 illustrates a flow diagram depicting a process for scrubbing air for use with a galvanic cell, according to some embodiments of the invention.

FIG. 3 illustrates a flow diagram depicting a process for making a galvanic cell utilizing a gas scrubber, according to some embodiments of the invention.

FIG. 4 illustrates a flow diagram depicting a process for making a gas scrubber for use with a galvanic cell, according to some embodiments of the invention.

FIG. 5 illustrates a graphical view of the effects of carbon dioxide poisoning on a galvanic cell, according to some embodiments of the invention.

FIG. 6 illustrates a graphical view of carbon dioxide adsorbed by triethanolamine (TEA), according to some embodiments of the invention.

FIG. 7 illustrates a graphical view of a gas chromatography-mass spectrometry (GC-MS) characterization of triethanolamine (TEA) in the adsorbed and non-adsorbed state, according to some embodiments of the invention.

FIG. 8 illustrates a graphical view of the regeneration cycle of carbon dioxide adsorbed by an active material, according to some embodiments of the invention.

FIG. 9 illustrates a flow diagram depicting a process for making a active materials layer, according to some embodiments of the invention.

FIG. 10 illustrate an absorption/desorption cycle of CO2 by MEA/C as an active material in a fixed bed reactor, according to some embodiments of the invention.

FIG. 11 illustrates an absorption/desorption cycle of CO2 by polyethylimine/C as an active material in a scrubber system, according to some embodiments of the invention.

### DETAILED DESCRIPTION

Embodiments of the invention may relate to a gas scrubber for use in a fuel cell or battery. In one embodiment, a gas scrubber for use in a rechargeable fuel cell or metal/air battery is provided.

References in the specification to “one embodiment,” “an embodiment,” “an example embodiment,” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one of ordinary skill in the art to affect such feature, structure, or characteristic in connection with other embodiments whether or not explicitly described.

Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value.

As used herein, the term membrane refers to a selective barrier that permits passage of hydroxide ions generated at the cathode through the membrane to the anode for oxidation of hydrogen at the anode to form water and heat. The terms anode and anodic electrode refer to an electrode that may be fabricated from metal hydride materials such as LaNi₅ and TiNi types of alloys. The terms cathode and cathodic electrode refer to an electrode that may be fabricated from metal or metal oxides and may include a catalyst. At the cathode or cathodic electrode, oxygen from air is reduced by free electrons from the usable electric current, generated at the anode, that combine with water, to form hydroxide ions and heat. The cathode in the fuel cell embodiments described herein, is, for some embodiments, graphite, and carbon-based materials. Suitable fuels cell may include a rechargeable fuel cell, an alkaline fuel cell, or a metal/air battery.

In the drawings, like numerals describe substantially similar components throughout the several views. These embodiments are described in sufficient detail to enable one of ordinary skill in the art to practice the invention.

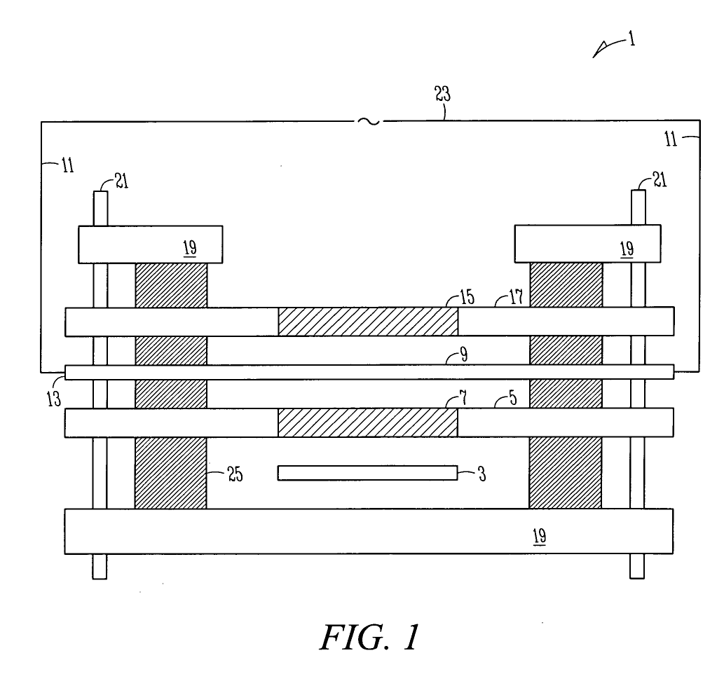

One embodiment of the invention, illustrated generally in FIG. 1, includes a galvanic cell utilizing a gas scrubber 1. The galvanic cell unit 3 may be a rechargeable fuel cell unit, alkaline fuel cell or metal/air battery, for example.

A first shutter support layer 17 provides a first shutter 15 that is adjacent to ambient air 23. The first shutter 15 controls access and flow of air or oxygen into and out of the device. An active material layer 9 is positioned below or underneath the first shutter support layer 17. The active material layer 9 may include an active material that can chemically or physically bind the gas to be isolated, such as carbon dioxide. The active material layer 9 is coupled to a resistance coil 11 that can be thermally or electrically activated to reverse the binding of the target gas, such as the release of bound carbon dioxide. The resistance coil 11 may also be fitted with a temperature control 13. A second shutter support layer 5 may include a second shutter 7, which controls the access and flow of the filtered air or oxygen to a galvanic cell unit 3. Pure oxygen generated during the charging process can help to release the bound carbon dioxide from the active material. Gaskets 25 and through bolts 21 support the components of the device within a housing 19. The positioning and control of the shutters, and the choice or selection of active materials, may allow for management of potentially disrupting target gases. Target gases may include one or more of carbon dioxide, sulfur oxides, or nitrogen oxides. Air or oxygen may be scrubbed of the target gas prior to contact with the electrolyte, and/or the electrodes, of the galvanic cell unit 3. The thermal or electric control of the resistance coil 11 may allow regeneration of the active materials of the active material layer 9. Such control may reduce or eliminate periodic maintenance, such as the replacement and/or replenishment of active materials.

The active material layer 9 may include one or more active materials that are capable of chemically and/or physically binding a target gas. Suitable active materials may include one or more of amines, amidines, or polymers or composites that include such nitrogen-based functionality and the like. Copolymers and blends of the active molecules or polymers can also be utilized in the invention. In one embodiment, the active material may include one or more of an amine, a pyrimidine, or an amide functional group.

Suitable amines may include one or more alkyl ethanolamine. Suitable alkyl ethanolamine may include one or more of triethanolamine (TEA), monoethanolamine (MEA), diethanolamine (DEA), or methyl diethanolamine (MDEA). Other suitable amines may include propanolamines, or other longer chain alkanes having a hydroxyl functionality and an amine functionality. Both primary and secondary amines may be utilized. In one embodiment, the active material may include polyamine functionality. Suitable amines may be commercially obtained at Dow Chemical (Midland, Mich.). Unless specified otherwise, all ingredients are commercially available from such common chemical suppliers as Alpha Aesar, Inc. (Ward Hill, Mass.), Sigma-Aldrich Company (St. Louis, Mo.), and the like.

Suitable amidines may include one or more of 1,8-diazabicyclo[5.4.0]-undec-7-ene (DBU), tetrahydropyrimidine (THP), N-methyltetrahydropyrimidine (MTHP), or polystyrene, polymethacrylate, polyacrylate etc., modified by DBU, THP or MTHP for example. In one embodiment, the amidine may include one or more of a bis-amidine, tris-amidine, or tetra-amidine, or a salt of any of these.

In one embodiment, the active polymer may be produced through radical polymerization, cationic polymerization, anionic polymerization, group transfer polymerization, ring-opening polymerization, ring-open metathesis polymerization, coordination polymerization, condensation polymerization, etc. The active polymer may be also produced by modification of a premade polymer structure using suitable active molecules. In one embodiment, the amidine may include a compound having the general formula X—Y(Z)n. In this formula, X is a moiety of: 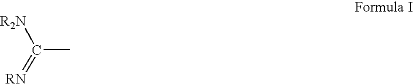
wherein each R is, independently, H, an optionally substituted alkyl, alkenyl, aryl, alkaryl, or alkenylaryl group, Y is a bond or a linking group, Z is H or a moiety according to Formula I, which may be the same or different than X, and n is an integer from 1 to 3.

Alkyl means an aliphatic hydrocarbon group that may be linear or branched having from 1 to about 15 carbon atoms, in some embodiments 1 to about 10 carbon atoms. Branched means that one or more lower alkyl groups such as methyl, ethyl, or propyl are attached to a linear alkyl chain. Lower alkyl means having 1 to about 6 carbon atoms in the chain, which may be linear or branched. One or more halo atoms, cycloalkyl, or cycloalkenyl groups may be a substitute for the alkyl group.

Alkenyl means an aliphatic hydrocarbon group containing a carbon-carbon double bond and which may be straight or branched having 2 to about 15 carbon atoms in the chain. Preferred alkenyl groups have 2 to about 10 carbon atoms in the chain, and more preferably 2 to about 6 carbon atoms in the chain. Lower alkenyl means 2 to about 4 carbon atoms in the chain, which may be straight or branched. The alkenyl group may be substituted by one or more halo atoms, cycloalkyl, or cycloalkenyl groups. Cycloalkyl means a non-aromatic mono- or multicyclic ring system of about 3 to about 12 carbon atoms. Exemplary cycloalkyl rings include cyclopentyl, cyclohexyl, and cycloheptyl. The cycloalkyl group may be substituted by one or more halo atoms, methylene, alkyl, cycloalkyl, heterocyclyl, aralkyl, heteroaralkyl, aryl or heteroaryl. Hetero means oxygen, nitrogen, or sulfur in place of one or more carbon atoms. Cycloalkenyl means a non-aromatic monocyclic or multicyclic ring system containing a carbon-carbon double bond and having about 3 to about 10 carbon atoms. The cycloalkenyl group may be substituted by one or more halo atoms, or methylene, alkyl, cycloalkyl, heterocyclyl, aralkyl, heteroaralkyl, aryl, or heteroaryl groups.

Aryl means an aromatic carbocyclic radical containing about 6 to about 12 carbon atoms. Exemplary aryl groups include phenyl or naphthyl optionally substituted with one or more aryl group substituents which may be the same or different, where “aryl group substituent” includes hydrogen, alkyl, cycloalkyl, optionally substituted aryl, optionally substituted heteroaryl, aralkyl, aralkenyl, aralkynyl, heteroaralkyl, heteroaralkenyl, heteroaralkynyl, hydroxy, hydroxyalkyl, alkoxy, aryloxy, aralkoxy, carboxy, acyl, aroyl, halo, nitro, cyano, carboxy, alkoxycarbonyl, aryloxycarbonyl, aralkoxycarbonyl, acylamino, aroylamino, alkylsulfonyl, arylsulfonyl, and other known groups. Alkaryl means an aryl-alkyl-group in which the aryl and alkyl are as previously described. Alkenylaryl means an aryl-alkenyl-group in which the aryl and alkenyl are as previously described.

In the general formula X—Y(Z)n, Y can be a bond or a linking group R′, which may be, or include, a hetero-atom such as oxygen, sulfur, phosphorous, or nitrogen, and the like. The linking group R′ may be an alkyl, alkenyl, aryl, or alkaryl group having from 1 to about 15 carbon atoms, which may be linear or branched, and which may be non-fluorinated, fluorinated, or perfluorinated. n is greater than 1. In one embodiment, the amidine may include one or more carboxylate salts of an amidine, which amidine and/or salt optionally can be fluorinated or perfluorinated.

The carbon dioxide may react with the active materials to form such products as zwitterions adducts and ammonium carbamate, for example. Active materials may be selected based on the ability to physically bind a target gas, which if carbon dioxide may include carbon fiber compounds and their composites. For example, carbon fiber composite molecular sieve (CFCMS) can adsorb carbon dioxide. Other suitable materials for physical binding of a target gas may include carbon nanotubes, buckyballs or fullerenes, porous ceramics, zeolites, and the like.

Such active materials can adsorb carbon dioxide in low temperatures during the discharge process of the galvanic cell unit 3 by either a chemical reaction, physical adsorption or both. The active materials can be regenerated within the active material layer 11 by applying a thermal treatment in the range of greater than about 65 degrees Celsius to the resistance coil during the charge period of the galvanic cell unit 3. In one embodiment, the thermal treatment may be less than about 120 degrees Celsius. Further, the temperature range may be from about 65 degrees Celsius to about 80 degrees Celsius, from about 80 degrees Celsius to about 100 degrees Celsius, from about 100 degrees Celsius to about 110 degrees Celsius, or from about 110 degrees Celsius to about 120 degrees Celsius. Alternatively or additionally, applying a low voltage to the resistance coil may regenerate the active materials.

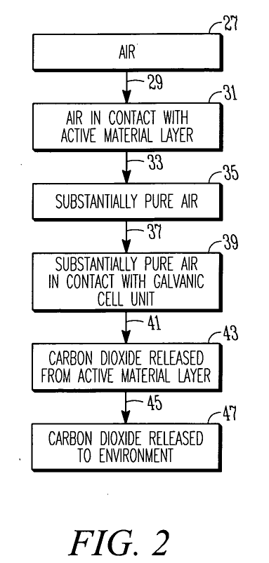

Referring to FIG. 2, a flow diagram depicts a process for scrubbing a gas from air or oxygen, according to some embodiments of the invention. Air 27 or oxygen diffuses through an opened first shutter 29 so that the air may contact an active material layer 31. The target species, such as carbon dioxide, may be removed from the air 27 by interaction with an active material within the active material layer, which then provides substantially pure air 35 with the concentration of carbon dioxide less than 10%. The first shutter closes to cut off any further supply of ambient air and a second shutter opens 37, allowing the substantially pure air 35 to come in contact with a galvanic cell unit 39. The second shutter closes, and a thermal or electrical charge may be applied 41 to a resistance coil coupled to the active material layer, which releases the carbon dioxide 43 bound to or in the active material layer. The first shutter may be opened 45 to release the carbon dioxide back to the ambient environment 47. The active material layer may be regenerated and ready to begin a new cycle of adsorbing and releasing the target species, such as carbon dioxide.

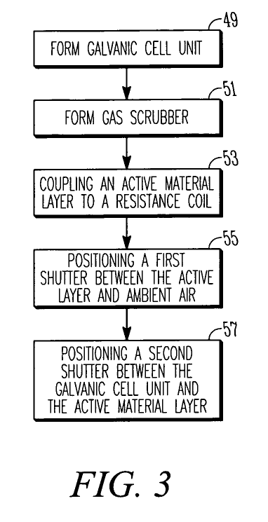

FIG. 3 describes a process for making a galvanic cell utilizing a gas scrubber, according to some embodiments of the invention. A galvanic cell unit may be formed 49. The galvanic cell unit may be a rechargeable fuel cell, alkaline fuel cell or metal/air battery, for example. A gas scrubber may be formed 51. The gas scrubber includes coupling an active material layer to a resistance coil 53. A first shutter may be positioned between the active material layer and the ambient air 55. A second shutter may be positioned between the galvanic cell unit and the active material layer 57.

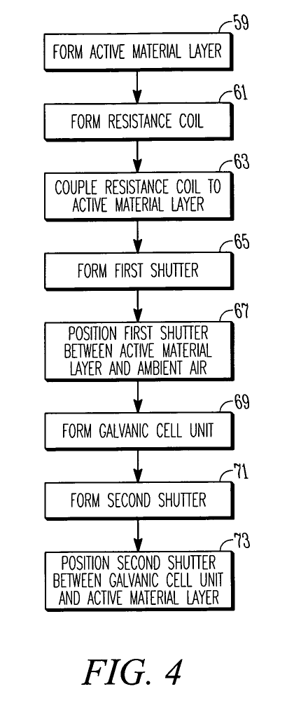

Referring to FIG. 4, a process for making a gas scrubber for use with a galvanic cell is shown, according to some embodiments of the invention. An active material layer 59, and a resistance coil 61 may be formed. The resistance coil may be coupled to the active material layer 63. A first shutter may be formed 65 and positioned between the active material layer and the ambient air 67. A galvanic cell unit may be formed 69. A second shutter may be formed 71 and positioned between the galvanic cell unit and the active material layer 73.

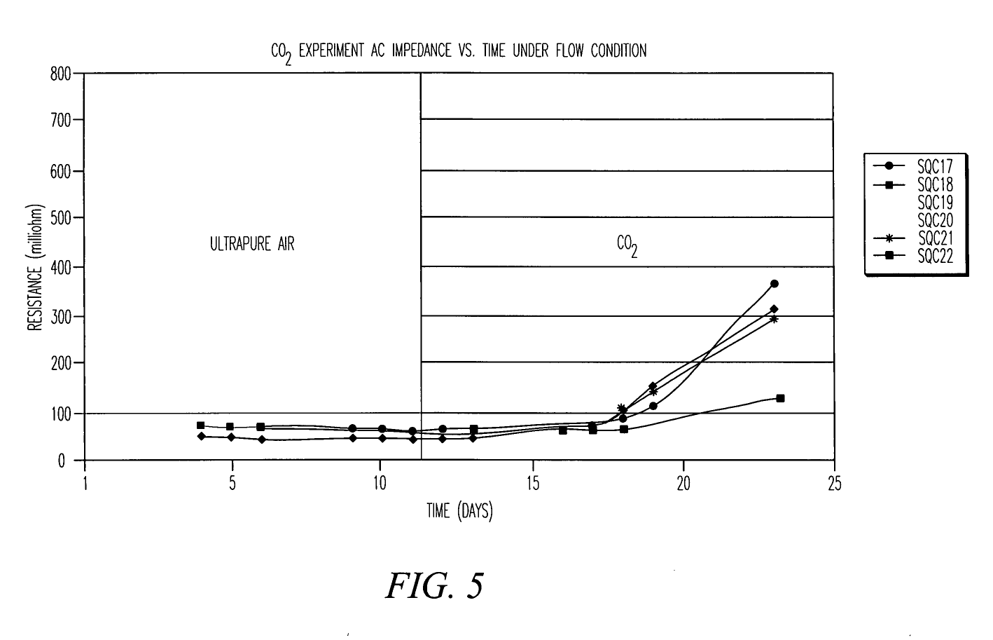

Referring to FIG. 5, a graphical view of the effects of carbon dioxide poisoning on a galvanic cell is shown, according to some embodiments of the invention. Typically, the galvanic cell is tested in a humidity-controlled chamber at room temperature. The relative humidity is set to 70% in order to avoid the water starvation problem. Over a determined number of days, the galvanic cell shows little to no increase in resistance in the presence of pure air. Once the air with 300 ppm concentration of carbon dioxide is introduced, the resistance of the cell greatly increases after a few days. The effects of carbon dioxide poisoning may be thereby demonstrated.

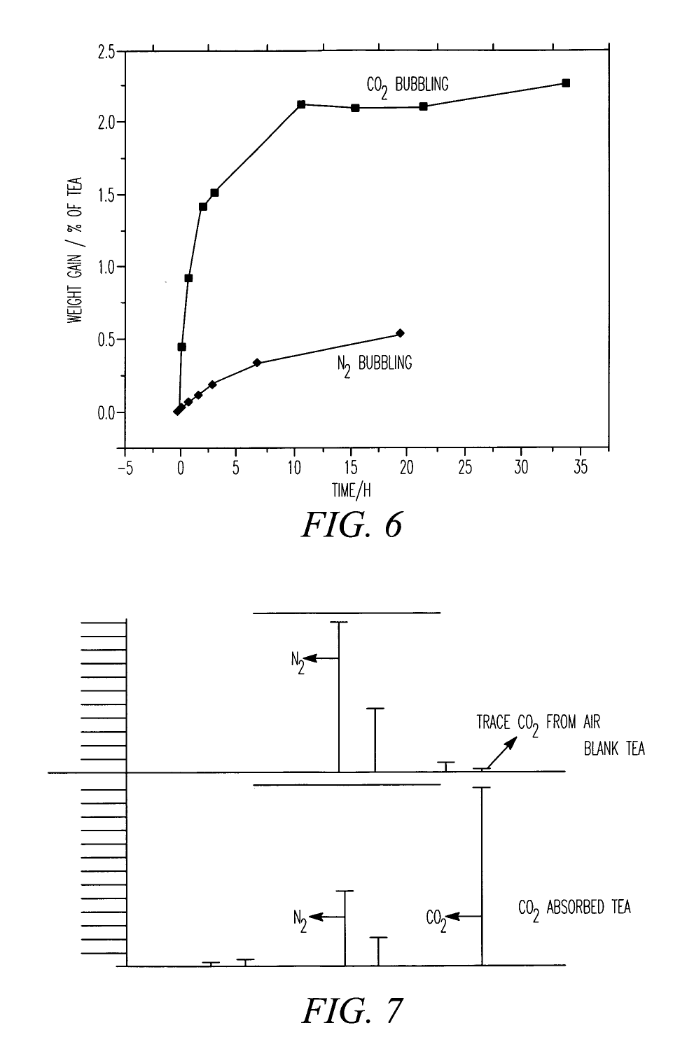

Referring to FIG. 6, a graphical view of carbon dioxide adsorbed by triethanolamine (TEA) is shown. Triethanolamine (TEA) may be used as an active material to bind carbon dioxide in the air. The reaction of TEA and carbon dioxide may be as follows:
(C₂H₄OH)₃N+CO₂+H₂O [symbol] (C₂H₄OH)₃NH⁺+HCO₃⁻
The reaction has a theoretical fixing efficiency of 29.5%. FIG. 6 displays the weight increase of TEA at room temperature in the presence of carbon dioxide compared to the nitrogen gas without carbon dioxide. FIG. 7 shows a gas chromatography-mass spectrometry (GC-MS) characterization of triethanolamine (TEA) in the adsorbed and non-adsorbed state, according to some embodiments of the invention. No CO₂ was detected with blank TEA, while strong CO₂ signal was tested with CO₂ adsorbed TEA. The GC-MS data in FIG. 7 may verify the adsorption of carbon dioxide by TEA. The carbon dioxide may be released at 120 degrees Celsius.

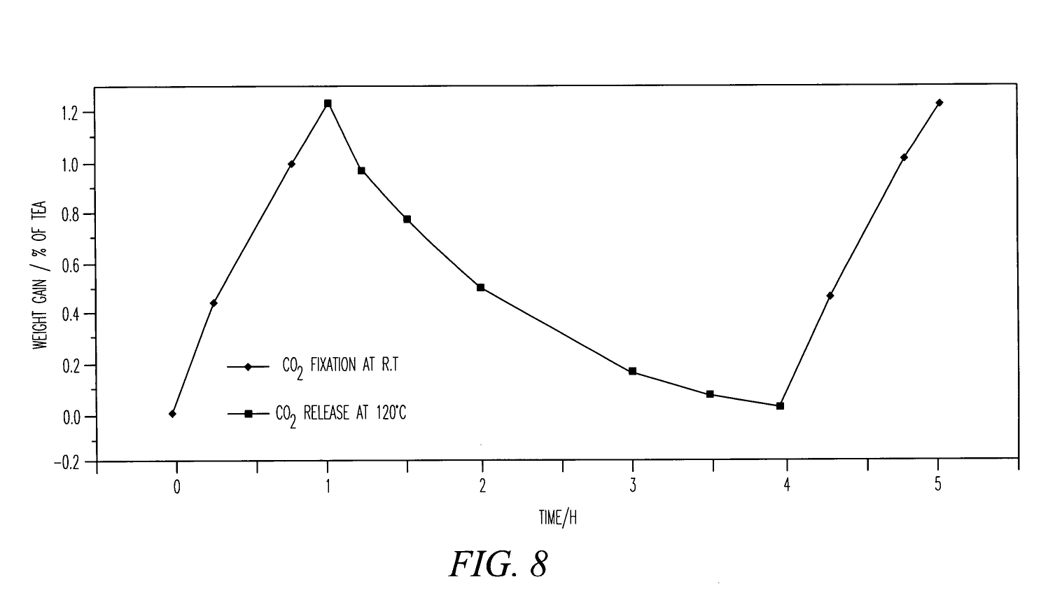

Referring to FIG. 8, a graphical view of the regeneration cycle of carbon dioxide adsorbed by an active material may be shown. TEA may be the active material used to adsorb carbon dioxide. The first section of the graph shows the fixation of carbon dioxide at room temperature, displayed by the increase in weight of TEA. The carbon dioxide may be released by applying heat or electricity to the resistance coil coupled to the active material layer. The weight of TEA subsequently decreases as the carbon dioxide releases. The cycle can be repeated.

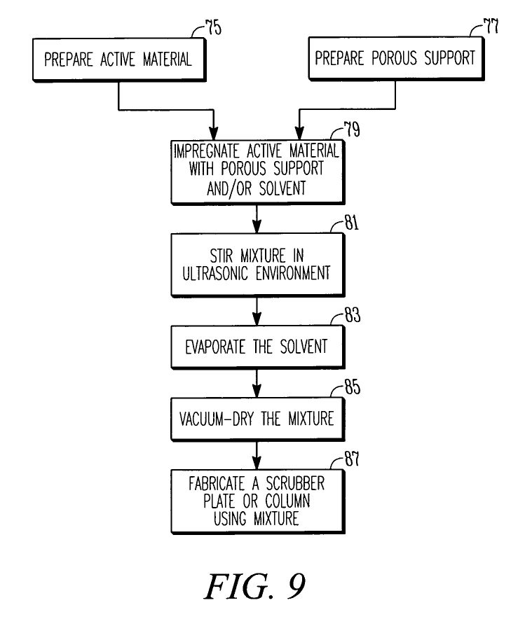

FIG. 9 shows a procedure of preparing scrubber material by supporting the active components on a porous support, according to some embodiments of the invention. Active material 75 and porous support 77 are first prepared. The porous support may be inorganic material or polymer material. The active material is then mixed with support material and a certain amount of solvent 79. The objective of adding solvent is to either dissolve the active material or decrease the viscosity of active material. The solvent may be deionized water or organic solvent, for example. This mixture is then stirred for a period of time under ultrasonic condition 81 to ensure the absorption of active material onto the surface of pores of support material. The mixture is then dried to evaporate the solvent 83. Finally the mixture is vacuum dried 85 for some time to remove the trace of solvent. Using this mixture, a scrubber plate or column is then fabricated 87. The scrubber may be shaped to a plate, a film, a column, a cube or any other geometry. The scrubber may be fabricated on organic, inorganic or metal substrates to help enhance mechanical strength, such as porous plastic plate, silica wafer or Ni foam.

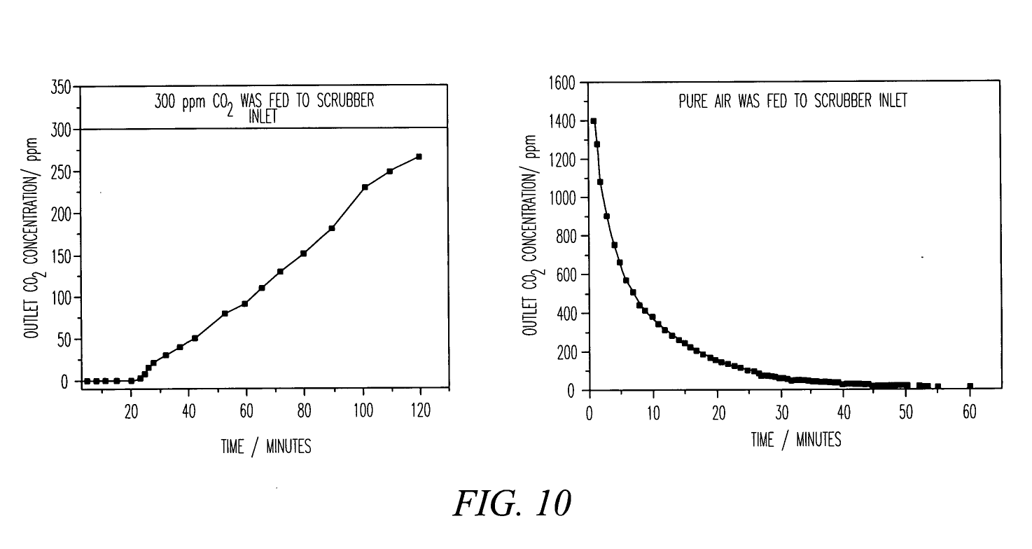

FIG. 10 shows an absorption/desorption cycle using active carbon supported MEA as scrubber material, according to some embodiments of the invention. Three hundred ppm CO₂ is fed to a fixed bed reactor comprising MEA/C. Within 21 minutes no substantial CO₂ is detected at the outlet of the reactor. The absorption capacity of this material is 90 μmol/g. After heating at 60° C. for 1 h, almost all CO₂ bound to the active material is released with the aid of pure air flowing.

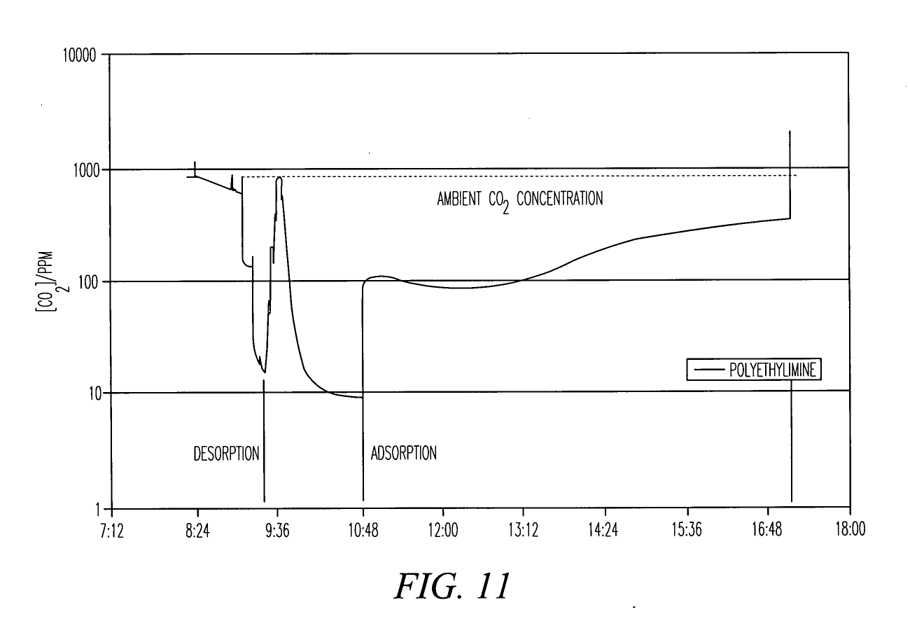

Referring to FIG. 11, polyethylimine/C is used as active material in a CO₂ scrubber system described in the above embodiment. CO₂ is fixed by the scrubber in a diffusion mode by which no artificial convection of gases is imposed to the system. The system scrubbed CO₂ for approximately 3 hours with less than 10% of CO₂ breakthrough. The material is also regenerable when heat is introduced.

The embodiments described herein are examples of compositions, structures, systems and methods having elements corresponding to the elements of the invention recited in the claims. This written description may enable one of ordinary skill in the art to make and use embodiments having alternative elements that likewise correspond to the elements of the invention recited in the claims. The scope thus includes compositions, structures, systems and methods that do not differ from the literal language of the claims, and further includes other compositions, structures, systems and methods with insubstantial differences from the literal language of the claims. While only certain features and embodiments have been illustrated and described herein, many modifications and changes may occur to one of ordinary skill in the relevant art. The appended claims are intended to cover all such modifications and changes.

What is claimed is:

1. A gas scrubber, comprising:
an active material layer;
a resistance coil communicating with the active material layer;
a first shutter that is disposed between the active material layer and ambient air; and
a second shutter that is between a galvanic cell unit and the active material layer.

2. The gas scrubber of claim 1, wherein the active material layer comprises an active material capable of binding carbon dioxide.

3. The gas scrubber of claim 2, wherein the active material comprises an amine.

4. The gas scrubber of claim 2, wherein the active material comprises an amine-functionalized polymer, a copolymer, blends of an amine-functionalized polymer and copolymer, or combinations thereof.

5. The gas scrubber of claim 3, wherein the amine comprises one or more of monoethanolamine, diethanolamine, or triethanolamine.

6. The gas scrubber of claim 2, wherein the active material comprises one or more amidine.

7. The gas scrubber of claim 2, wherein the active material comprises an amidine-functionalized polymer, a copolymer, blends of an amidine-functionalized polymer and copolymer, or combinations thereof.

8. The gas scrubber of claim 6, wherein the amidine comprises 1,8-diazabicyclo[5.4.0]-undec-7-ene (DBU), tetrahydropyrimidine (THP), N-methyltetrahydropyrimidine (MTHP), or polystyrene, polymethacrylate, polyacrylate etc., modified by DBU, THP or MTHP or combinations thereof.

9. The gas scrubber of claim 2, wherein the active material is a polymer produced through radical polymerization, cationic polymerization, anionic polymerization, group transfer polymerization, ring-opening polymerization, ring-open metathesis polymerization, coordination polymerization, condensation polymerization, or combinations thereof.

10. The gas scrubber of claim 2, wherein the active material is a polymer produced by modification of a premade polymer structure using suitable active molecules.

11. The gas scrubber of claim 2, wherein the active material is supported by a porous material.

12. The gas scrubber of claim 11, wherein the porous material comprises a porous inorganic material.

13. The gas scrubber of claim 12, wherein the porous inorganic material comprises a molecular sieve.

14. The gas scrubber of claim 11, wherein the porous material comprises a porous carbon material.

15. The gas scrubber of claim 14, wherein the porous material comprises an active carbon.

16. The gas scrubber of claim 11, wherein the porous material comprises a carbon fiber.

17. The gas scrubber of claim 11, wherein the porous material comprises a carbon tube.

18. The gas scrubber of claim 11, wherein the porous material comprises a charcoal.

19. The gas scrubber of claim 11, wherein the porous material comprises a acetylene black.

20. The gas scrubber of claim 11, wherein the porous material comprises a porous polymer material.

21. The gas scrubber of claim 1, wherein the galvanic cell unit comprises a rechargeable fuel cell.

22. The gas scrubber of claim 1, wherein the galvanic cell unit comprises an alkaline fuel cell.

23. The gas scrubber of claim 1, wherein the galvanic cell unit comprises a metal/air battery.

24. The gas scrubber of claim 1, wherein the resistance coil is responsive to one or both of heat or electricity such that application of one or both of heat or electricity unbinds or releases carbon dioxide from the active material layer.

25. A method of preparing active material layer, comprising:
preparing an active material;
preparing a porous support material;
mixing the active material with the support material and an amount of solvent,
sufficient to create a mixture;
stirring the mixture for a period of time under ultrasonic condition;
drying the mixture to evaporate the solvent;
vacuum-drying the mixture for some time to remove the trace of solvent; and
fabricating active material layer.

26. The method of claim 25, wherein the solvent comprises water or an organic liquid.

27. The method of claim 25, wherein the active material layer comprises a shape including a plate, a film, a column, a cube or combinations thereof.

28. The method of claim 25, wherein the fabricating an active material layer comprises binding at least a portion of the active material layer on organic, inorganic or metal substrates.

29. The method of claim 28, wherein the organic, inorganic or metal substrates comprise a porous plastic plate, silica wafer, Ni foam or combinations thereof.

30. A method, comprising:
allowing ambient air to contact an active material layer, wherein the ambient air comprises a target gas and the active material layer comprises an amidine;
binding the target gas to the amidine; and
flowing the ambient air, which is free of the target gas, to contact an electrode.

31. The method as defined in claim 30, wherein the target gas is carbon dioxide.

32. The method as defined in claim 30, wherein the electrode is a cathode.

33. A method, comprising:
opening both a first shutter and a second shutter to unblock a path from ambient air to an electrode through an active material layer;
flowing ambient air through the open first shutter to contact the active material layer, wherein the ambient air comprises a target gas and the active material layer comprises an active material;
binding the target gas to the active materials;
flowing the ambient air, which is free of the target gas, through the open second shutter to contact the electrode.

34. The method as defined in claim 33, wherein the binding comprises chemically binding or physically binding the target gas.

35. The method as defined in claim 33, wherein the active material layer comprises an amine or an amidine and the binding is chemical binding.

36. The method as defined in claim 33, wherein the active material layer comprises a molecular sieve and the binding is physical binding.

37. The method as defined in claim 33, further comprising applying thermal stimulus, electric stimulus, or both stimuli to a resistance coil in contact with the active material layer in an amount that is sufficient to release otherwise bound target gas from the active material.

38. The method of claim 37, further comprising opening the first shutter to release otherwise bound target gas to ambient air.

39. The method of claim 37, comprising closing the second shutter.

40. The method of claim 37, comprising purging pure air or oxygen into the active material to help the release of the bound target gas from the active material.

41. A system, comprising:
means for controlling contact of ambient air to an electrode, wherein the ambient air comprises a target gas; and
means for binding the target gas.
